(19) United States
(12) Patent Application Publication
(10) Pub. No.: US 2024/0214171 A1
(43) Pub. Date: Jun. 27, 2024

(54) TRACKING TRANSMISSION CONFIGURATION INDICATION STATES IN INTER-CELL BEAM MANAGEMENT

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/574,643

(22) PCT Filed: Aug. 24, 2021
(86) PCT No.: PCT/CN2021/114206

§ 371 Date: Dec. 27, 2023

(51) Int. Cl. H04L 5/00

(52) U.S. Cl. CPC H04L 5/0091; H04L 5/0048

(57) ABSTRACT

Various aspects of the present disclosure generally relate to wireless communication. In some aspects, a user equipment (UE) may receive, from a serving cell, information indicating a set of activated channel state information (CSI) trigger states that are respectively associated with a set of transmission configuration indication (TCI) states each having a respective source reference signal. The UE may track, based at least in part on a capability to concurrently track multiple TCI states, a subset of TCI states, of the set of TCI states, including at least one TCI state for which the respective source reference signal is a non-serving cell synchronization signal block (SSB). Numerous other aspects are provided.

### FIELD OF THE DISCLOSURE

Aspects of the present disclosure generally relate to wireless communication and specifically, to tracking transmission configuration indication (TCI) states in inter-cell beam management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In a wireless network, a UE may be configured with one or more channel state information (CSI) trigger states that may be used to trigger an aperiodic CSI transmission or an aperiodic CSI report, among other examples. For example, each CSI trigger state may be associated with one or more aperiodic CSI report configurations, and each aperiodic CSI report configuration may be associated with at least a set of channel state information reference signals (CSI-RS) and a transmission configuration indication (TCI) state that provides quasi co-location (QCL) information for a respective beam associated with each CSI-RS (for example, a beam that the UE is to use to receive the associated CSI-RS). When a serving cell transmits a signal associated with an activated CSI trigger state to the UE, the UE may receive the corresponding CSI-RS using the TCI state associated with the CSI trigger state and subsequently transmit an aperiodic CSI report that includes one or more measurements that the UE obtained from the CSI-RS (for example, a channel quality indicator or precoding matrix indicator, among other examples). Accordingly, in cases where the UE is configured with an activated CSI trigger state, the UE may need to track information associated with the corresponding TCI state (for example, the QCL properties associated with the source reference signal for the corresponding TCI state) to enable reception of the CSI-RS.

Furthermore, in a wireless network that supports a unified TCI framework (for example, using a joint downlink and uplink TCI state or separate downlink and uplink TCI states), the CSI trigger states that are configured and activated for a UE may be used for beam management. For example, one or more aperiodic CSI trigger states may be used for inter-cell beam management, in which case the source reference signal associated with the corresponding TCI states may include synchronization signal blocks (SSBs) from one or more non-serving cells that have different physical cell identities (PCIs) than the serving cell. Accordingly, in order to support inter-cell operation (for example, multi transmission reception point (mTRP)) operation, the UE may need to know time domain positions, transmission periodicities, transmission powers, or other parameters associated with the one or more non-serving cell SSBs. Consequently, in addition to tracking information associated with TCI states associated with CSI trigger states that are configured for aperiodic CSI transmission, aperiodic CSI reporting, or other purposes (for example, beam management or tracking within the serving cell), the UE may need to track information associated with one or more TCI states associated with CSI trigger states configured for inter-cell beam management. However, as described above, the TCI states that are associated with CSI trigger states configured for inter-cell beam management may have source reference signals that correspond to SSBs from non-serving cells that have different PCIs than the serving cell, which may present challenges in cases where the UE has a capability to concurrently track only a limited quantity of TCI states associated with different PCIs.

### SUMMARY

Some aspects described herein relate to a user equipment (UE) for wireless communication. The user equipment may include at least one processor and at least one memory, communicatively coupled with the at least one processor, that stores processor-readable code. The processor-readable code, when executed by the at least one processor, may be configured to cause the user equipment to receive, from a serving cell, information indicating a set of activated channel state information (CSI) trigger states that are respectively associated with a set of transmission configuration indication (TCI) states each having a respective source reference signal. The processor-readable code, when executed by the at least one processor, may be configured to cause the user equipment to track, based at least in part on a capability to concurrently track multiple TCI states, a subset of TCI states, of the set of TCI states, including at least one TCI state for which the respective source reference signal is a non-serving cell synchronization signal block (SSB).

Some aspects described herein relate to a method of wireless communication performed by a UE. The method may include receiving, from a serving cell, information indicating a set of activated CSI trigger states that are respectively associated with a set of TCI states each having a respective source reference signal. The method may include tracking, based at least in part on a capability to concurrently track multiple TCI states, a subset of TCI states, of the set of TCI states, including at least one TCI state for which the respective source reference signal is a non-serving cell SSB.

Some aspects described herein relate to a non-transitory computer-readable medium that stores a set of instructions for wireless communication by a UE. The set of instructions, when executed by one or more processors of the UE, may cause the UE to receive, from a serving cell, information indicating a set of activated CSI trigger states that are respectively associated with a set of TCI states each having a respective source reference signal. The set of instructions, when executed by one or more processors of the UE, may cause the UE to track, based at least in part on a capability to concurrently track multiple TCI states, a subset of TCI states, of the set of TCI states, including at least one TCI state for which the respective source reference signal is a non-serving cell SSB.

Some aspects described herein relate to an apparatus for wireless communication. The apparatus may include means for receiving, from a serving cell, information indicating a set of activated CSI trigger states that are respectively associated with a set of TCI states each having a respective source reference signal. The apparatus may include means for tracking, based at least in part on a capability to concurrently track multiple TCI states, a subset of TCI states, of the set of TCI states, including at least one TCI state for which the respective source reference signal is a non-serving cell SSB.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of physical channels and reference signals in a wireless network in accordance with the present disclosure.

FIG. 4 is a diagram illustrating an example of using beams for communications between a base station and a UE in accordance with the present disclosure.

FIG. 5 is a diagram illustrating an example associated with tracking transmission configuration indication (TCI) states in inter-cell beam management in accordance with the present disclosure.

FIG. 6 is a flowchart illustrating an example process performed, for example, by a UE in accordance with the present disclosure.

FIG. 7 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to behavior related to tracking transmission configuration indication (TCI) states at a user equipment (UE) configured with one or more channel state information (CSI) trigger states for inter-cell beam management. Some aspects more specifically relate to inter-cell beam management scenarios where a unified TCI framework is used to provide a beam indication (for example, using a joint downlink and uplink TCI state or separate downlink and uplink TCI states) and the UE has a capability to concurrently track a limited quantity of TCI states associated with different physical cell identities (PCIs). For example, in some aspects, the UE may be configured with a set of activated CSI trigger states that are each associated with a TCI state that has a source reference signal from which to derive quasi co-location (QCL) properties for an associated downlink beam, uplink beam, or joint downlink and uplink beam. Accordingly, the UE may be configured to track the TCI state associated with each respective activated CSI trigger state. Furthermore, in some cases, the set of activated CSI trigger states may include one or more CSI trigger states that are associated with a TCI state for which the source reference signal is a synchronization signal block (SSB) from a non-serving cell (for example, for inter-cell beam management). In such cases, the UE may track or maintain time and frequency offset information, QCL properties, or other information related to the respective non-serving cell SSB based on a capability to concurrently track TCI states associated with different PCIs. For example, the UE may have a capability to concurrently track up to a maximum quantity of non-serving cell SSBs or a maximum quantity of TCI states associated with non-serving cell SSBs that serve as source reference signals. Accordingly, the UE may track a total quantity of non-serving cell SSBs, or a total quantity of TCI states having non-serving cell SSBs serve as source reference signals, that does not exceed the corresponding UE capability. Furthermore, in cases where the TCI states to be tracked include a quantity of non-serving cell SSBs or a quantity of PCIs that exceeds the corresponding UE capability, the UE may drop, from the set of TCI states to be tracked, one or more TCI states that are associated with non-serving cell SSBs or non-serving cell PCIs until the total quantity of non-serving cell SSBs or the total quantity of PCIs to be tracked does not exceed the corresponding UE capability.

Particular aspects of the subject matter described in this disclosure can be implemented to realize one or more of the following potential advantages. In some examples, the described techniques can be used to provide consistent and predictable UE behavior when tracking TCI states for activated CSI trigger states in inter-cell beam management. Furthermore, in some examples, the described techniques may ensure that a serving cell (for example, a serving base station or transmission reception point (TRP)) does not configure the UE to track a quantity of non-serving cell SSBs or TCI states associated with source reference signals from non-serving cells that exceeds a concurrent tracking capability of the UE. In addition, by specifying one or more dropping rules that the UE is to apply when a set of tracked TCI states includes a quantity of non-serving cell SSBs or TCI states associated with source reference signals from a non-serving cell that exceeds the concurrent tracking capability of the UE, the serving cell may determine the TCI state(s) that the UE drops from the set of tracked TCI states based on the applicable rules, which reduces signaling overhead that may otherwise be incurred if the UE were to transmit information to the serving cell to indicate the dropped TCI state(s).

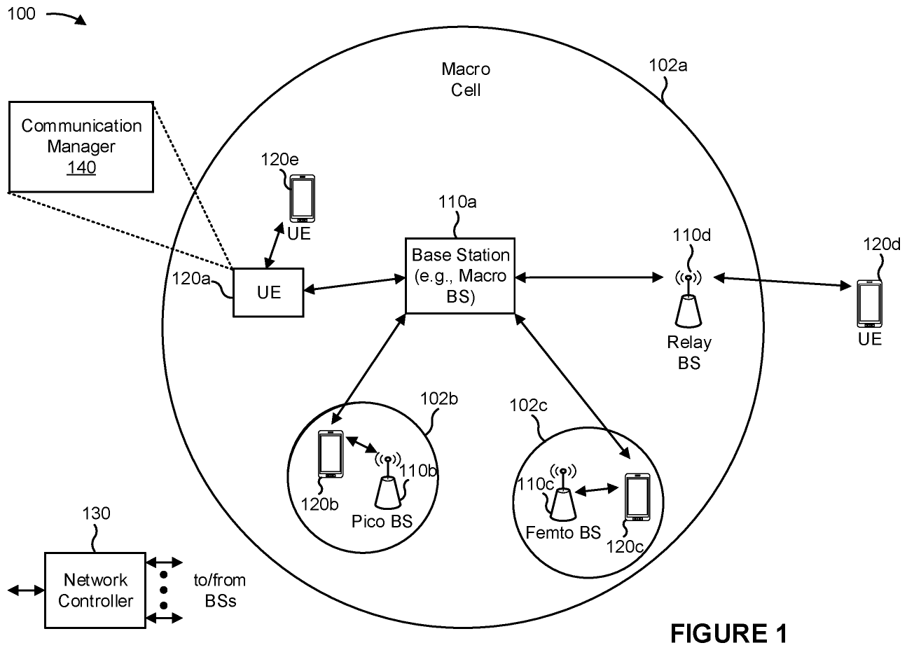

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a TRP. Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHZ,” if used herein, may broadly represent frequencies that may be less than 6 GHZ, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a serving cell, information indicating a set of activated channel state information (CSI) trigger states that are respectively associated with a set of transmission configuration indication (TCI) states each having a respective source reference signal; and track, based at least in part on a capability to concurrently track multiple TCI states, a subset of TCI states, of the set of TCI states, including at least one TCI state for which the respective source reference signal is a non-serving cell synchronization signal block (SSB). Additionally or alternatively, the communication manager 140 may perform one or more other operations described herein.

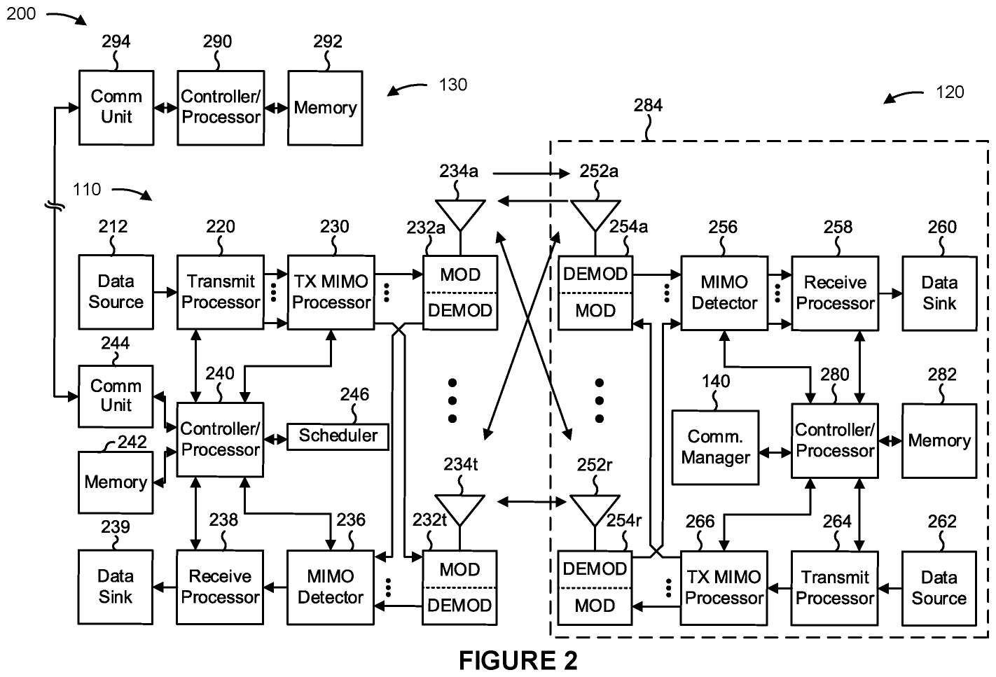

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

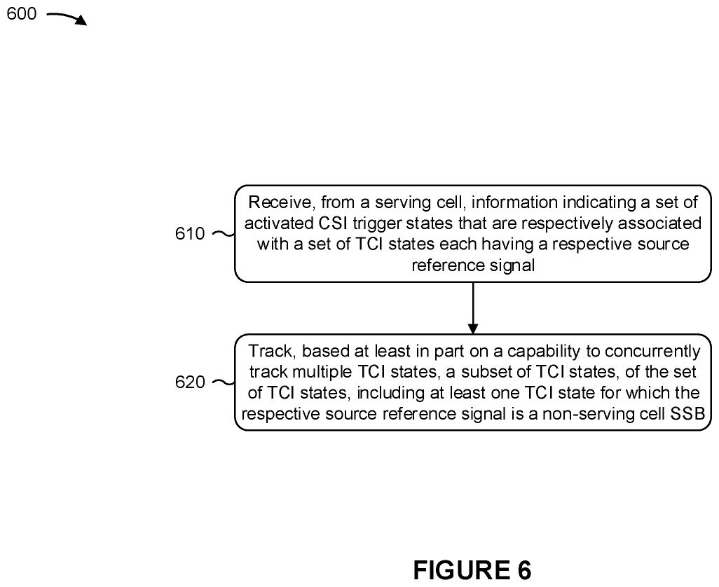

The controller/processor 240 of the base station 110, the controller/processor 280 of the UE 120, or any other component(s) of FIG. 2 may perform one or more techniques associated with tracking TCI states in inter-cell beam management, as described in more detail elsewhere herein. For example, the controller/processor 240 of the base station 110, the controller/processor 280 of the UE 120, or any other component(s) of FIG. 2 may perform or direct operations of, for example, process 600 of FIG. 6 or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6 or other processes as described herein. In some examples, executing instructions may include running the instructions, converting the instructions, compiling the instructions, or interpreting the instructions, among other examples.

In some aspects, the UE 120 includes means for receiving, from a serving cell, information indicating a set of activated CSI trigger states that are respectively associated with a set of TCI states each having a respective source reference signal; or means for tracking, based at least in part on a capability to concurrently track multiple TCI states, a subset of TCI states, of the set of TCI states, including at least one TCI state for which the respective source reference signal is a non-serving cell SSB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

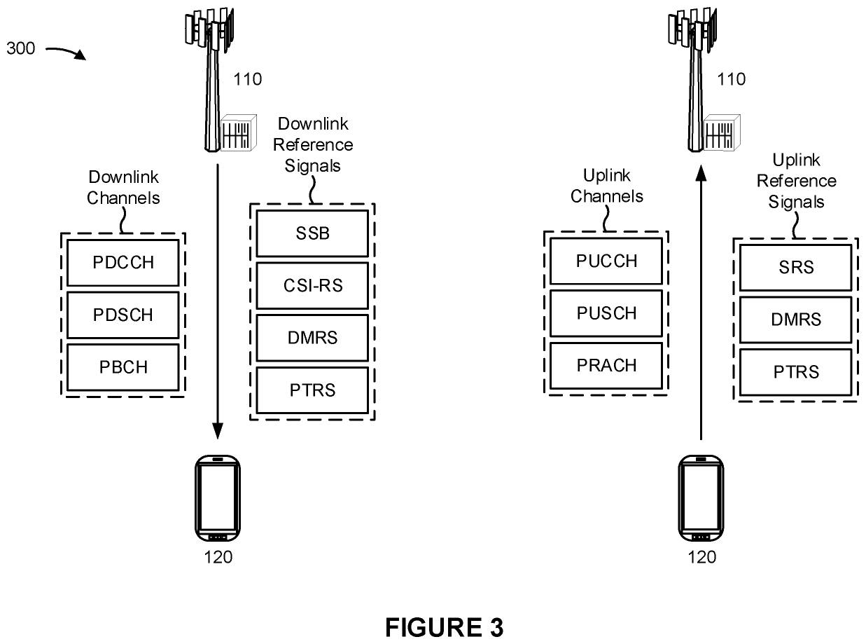

FIG. 3 is a diagram illustrating an example 300 of physical channels and reference signals in a wireless network in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (for example, ACK/NACK feedback or ACK/NACK information) in UCI on the PUCCH or the PUSCH.

As further shown, a downlink reference signal may include an SSB, a CSI reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection or beam management, which may include intra-cell beam management or inter-cell beam management.

A CSI-RS may carry information used for downlink channel estimation (for example, downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (for example, in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (for example, a rank), a precoding matrix (for example, a precoder), a modulation and coding scheme (MCS), or a refined downlink beam (for example, using a beam refinement procedure or a beam management procedure), among other examples.

A DMRS may carry information used to estimate a radio channel for demodulation of an associated physical channel (for example, PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (for example, rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (for example, on the PDSCH) and uplink communications (for example, on the PUSCH).

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

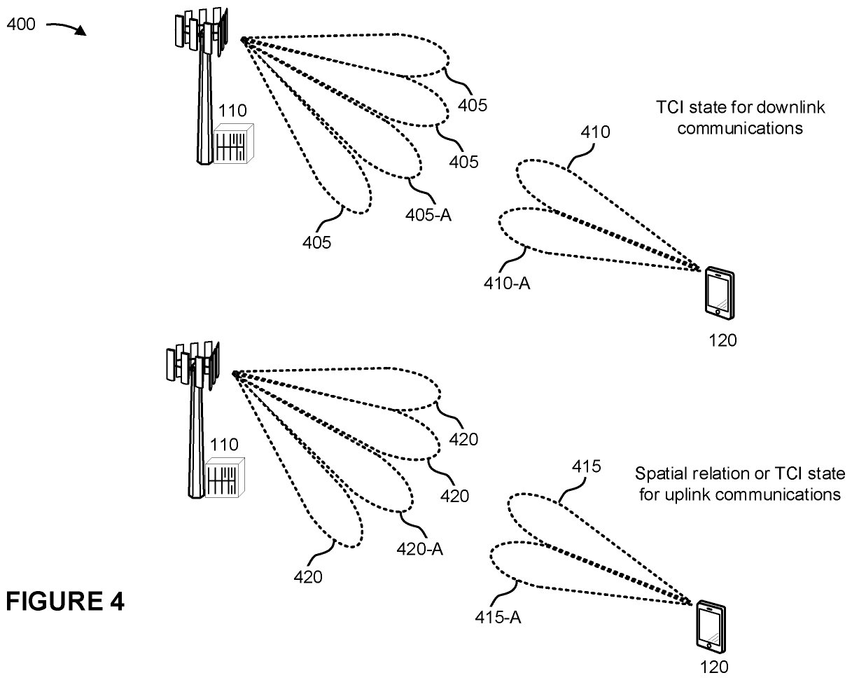

FIG. 4 is a diagram illustrating an example 400 of using beams for communications between a base station and a UE, in accordance with the present disclosure. As shown in FIG. 4, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a transmission configuration indication (TCI) state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or a spatial receive parameter, among other examples. In some examples, each BS transmit beam 405 may be associated with an SSB, and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates a spatial receive parameter (for example, QCL type D), the QCL type may correspond to analog receive beamforming parameters of a UE receive beam 410 at the UE 120. Thus, the UE 120 may select a corresponding UE receive beam 410 from a set of BPLs based at least in part on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A, and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

Additionally or alternatively, as shown in FIG. 4, the base station 110 and the UE 120 may communicate using a unified TCI framework, in which case the base station 110 may indicate a TCI state that the UE 120 is to use for beamformed uplink communications. For example, in a unified TCI framework, a joint TCI state (which may be referred to herein as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a PUSCH based on a dynamic grant or a configured grant or one or more dedicated PUCCH resources in a component carrier.

Additionally or alternatively, the unified TCI framework may support a separate downlink TCI state and a separate uplink TCI state to accommodate separate downlink and uplink beam indications (for example, in cases where a best uplink beam does not correspond to a best downlink beam, or vice versa). In such cases, each valid uplink TCI state configuration may contain a source reference signal to indicate an uplink transmit beam for a target uplink communication (for example, a target uplink reference signal or a target uplink channel). For example, the source reference signal may be an SRS, an SSB, or a CSI-RS, among other examples, and the target uplink communication may be a PRACH, a PUCCH, a PUSCH, an SRS, or a DMRS (for example, a DMRS for a PUCCH or a PUSCH), among other examples. In this way, supporting joint TCI states or separate downlink and uplink TCI states may enable a unified TCI framework for downlink and uplink communications, or may enable the base station 110 to indicate various uplink QCL relationships (for example, Doppler shift, Doppler spread, average delay, or delay spread, among other examples) for uplink TCI communication.

In a wireless network, a UE may be configured with one or more channel state information (CSI) trigger states that may be used to trigger an aperiodic CSI transmission or an aperiodic CSI report, among other examples. For example, each CSI trigger state may be associated with one or more aperiodic CSI report configurations, and each aperiodic CSI report configuration may be associated with at least a set of channel state information reference signals (CSI-RSs) and a TCI state that provides quasi co-location (QCL) information for a respective beam associated with each CSI-RS (for example, a beam that the UE is to use to receive the associated CSI-RS). When a serving cell transmits a signal associated with an activated CSI trigger state to the UE, the UE may receive the corresponding CSI-RS using the TCI state associated with the CSI trigger state and subsequently transmit an aperiodic CSI report that includes one or more measurements that the UE obtained from the CSI-RS (for example, a channel quality indicator or precoding matrix indicator, among other examples). Accordingly, in cases where the UE is configured with an activated CSI trigger state, the UE may need to track information associated with the corresponding TCI state (for example, the QCL properties associated with the source reference signal for the corresponding TCI state) to enable reception of the CSI-RS.

Furthermore, in a wireless network that supports a unified TCI framework (for example, using a joint downlink and uplink TCI state or separate downlink and uplink TCI states), the CSI trigger states that are configured and activated for a UE may be used for beam management. For example, one or more aperiodic CSI trigger states may be used for inter-cell beam management, in which case the source reference signal associated with the corresponding TCI states may include synchronization signal blocks (SSBs) from one or more non-serving cells that have different physical cell identities (PCIs) than the serving cell. Accordingly, in order to support inter-cell operation (for example, multi transmission reception point (mTRP)) operation, the UE may need to know time domain positions, transmission periodicities, transmission powers, or other parameters associated with the one or more non-serving cell SSBs. Consequently, in addition to tracking information associated with TCI states associated with CSI trigger states that are configured for aperiodic CSI transmission, aperiodic CSI reporting, or other purposes (for example, beam management or tracking within the serving cell), the UE may need to track information associated with one or more TCI states associated with CSI trigger states configured for inter-cell beam management. However, as described above, the TCI states that are associated with CSI trigger states configured for inter-cell beam management may have source reference signals that correspond to SSBs from non-serving cells that have different PCIs than the serving cell, which may present challenges in cases where the UE has a capability to concurrently track only a limited quantity of TCI states associated with different PCIs.

Various aspects relate generally to behavior related to tracking TCI states at a UE configured with one or more CSI trigger states for inter-cell beam management. Some aspects more specifically relate to inter-cell beam management scenarios where a unified TCI framework is used to provide a beam indication (for example, using a joint downlink and uplink TCI state or separate downlink and uplink TCI states) and the UE has a capability to concurrently track a limited quantity of TCI states associated with different PCIs. For example, in some aspects, the UE may be configured with a set of activated CSI trigger states that are each associated with a TCI state that has a source reference signal from which to derive QCL properties for an associated downlink beam, uplink beam, or joint downlink and uplink beam. Accordingly, the UE may be configured to track the TCI state associated with each respective activated CSI trigger state. Furthermore, in some cases, the set of activated CSI trigger states may include one or more CSI trigger states that are associated with a TCI state for which the source reference signal is an SSB from a non-serving cell (for example, for inter-cell beam management). In such cases, the UE may track or maintain time and frequency offset information, QCL properties, or other information related to the respective non-serving cell SSB based on a capability to concurrently track TCI states associated with different PCIs. For example, the UE may have a capability to concurrently track up to a maximum quantity of non-serving cell SSBs or a maximum quantity TCI states associated with non-serving cell SSBs that serve as source reference signals. Accordingly, the UE may track a total quantity of non-serving cell SSBs, or a total quantity TCI states having non-serving cell SSBs serve as source reference signals, that does not exceed the corresponding UE capability. Furthermore, in cases where the TCI states to be tracked include a quantity of non-serving cell SSBs or a quantity of PCIs that exceeds the corresponding UE capability, the UE may drop, from the set of TCI states to be tracked, one or more TCI states that are associated with non-serving cell SSBs or non-serving cell PCIs until the total quantity of non-serving cell SSBs or the total quantity of PCIs to be tracked does not exceed the corresponding UE capability.

Particular aspects of the subject matter described in this disclosure can be implemented to realize one or more of the following potential advantages. In some examples, the described techniques can be used to provide consistent and predictable UE behavior when tracking TCI states for activated CSI trigger states in inter-cell beam management. Furthermore, in some examples, the described techniques may ensure that a serving cell (for example, a serving base station or TRP) does not configure the UE to track a quantity of non-serving cell SSBs or TCI states associated with source reference signals from non-serving cells that exceeds a concurrent tracking capability of the UE. In addition, by specifying one or more dropping rules that the UE is to apply when a set of tracked TCI states includes a quantity of non-serving cell SSBs or TCI states associated with source reference signals from a non-serving cell exceeds the concurrent tracking capability of the UE, the serving cell may determine the TCI state(s) that the UE drops from the set of tracked TCI states based on the applicable rules, which reduces signaling overhead that may otherwise be incurred if the UE were to transmit information to the serving cell to indicate the dropped TCI state(s).

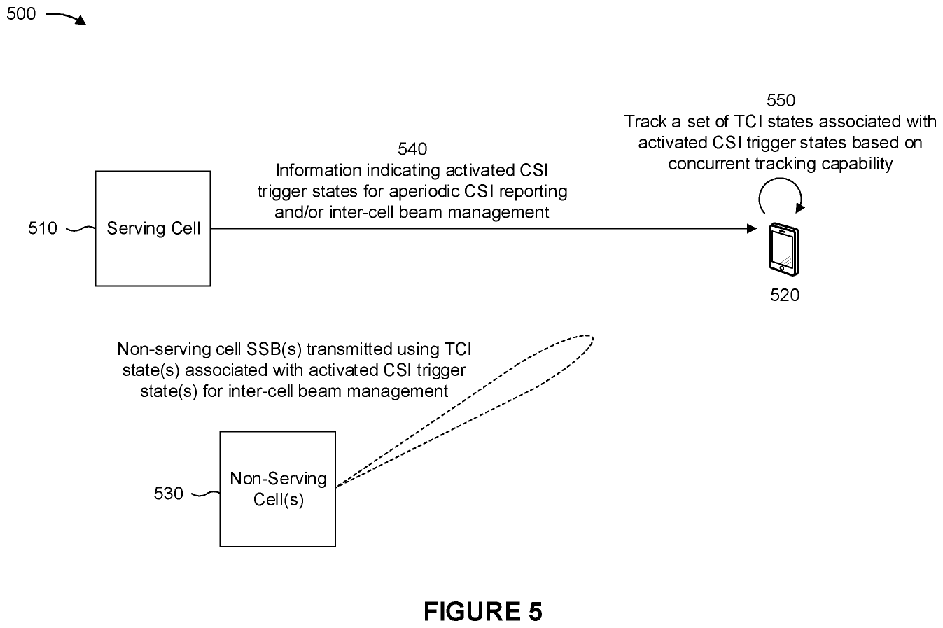

FIG. 5 is a diagram illustrating an example 500 associated with tracking TCI states in inter-cell beam management in accordance with the present disclosure. As shown in FIG. 5, example 500 includes communication between a serving cell 510 (for example, a serving base station or a serving TRP) and a UE 520. As further shown in FIG. 5, example 500 includes one or more non-serving cells 530 (for example, non-serving base stations or non-serving TRPs) that may transmit SSBs used for inter-cell beam management. In some aspects, the serving cell 510, the UE 520, and the non-serving cell(s) 530 may be included in a wireless network, such as wireless network 100. The serving cell 510 and the UE 520 may communicate via a wireless access link, which may include an uplink and a downlink.

As shown in FIG. 5, in a first operation 540, the serving cell 510 may transmit, and the UE 520 may receive, information that indicates one or more activated CSI trigger states for aperiodic CSI reporting or inter-cell beam management, among other examples. For example, in some aspects, the serving cell 510 may generally configure a large quantity (for example, up to one hundred and twenty eight (128)) CSI trigger states for the UE 520 using higher-layer signaling, such as RRC signaling (for example, using a (′SI-AperiodicTriggerState parameter). Each CSI trigger state that is configured for the UE 520 may be associated with one or more CSI report configurations (for example, using an AssociatedReportConfigInfo parameter), which may be associated with a TCI state that provides one or more QCL parameters for an associated source reference signal, such as time and frequency offset information or a spatial reception parameter. Furthermore, in some aspects, lower-layer signaling, such as a medium access control (MAC) control element (MAC-CE), may be used to indicate a subset of the configured CSI trigger states to be activated by down-selecting the CSI trigger states configured by the higher-layer signaling (for example, selecting up to eight (8) CSI trigger states to activate from up to 128 RRC-configured CSI trigger states). In some aspects, as described herein, the activated CSI trigger states indicated by the lower-layer signaling may be associated with one or more use cases, such as aperiodic CSI reporting. For example, to trigger an aperiodic CSI report, the serving cell 510 may transmit a lower-layer signal (for example, a MAC-CE or DCI) indicating an activated CSI trigger state, and the UE 520 may then schedule reception of a corresponding CSI-RS and transmission of a corresponding aperiodic CSI report. Furthermore, in some cases, the activated CSI trigger states may include one or more CSI trigger states used for inter-cell beam management in a unified TCI framework. In such cases, the one or more CSI trigger states used for inter-cell beam management may be associated with corresponding TCI states for which the source reference is an SSB transmitted by a non-serving cell 530, which the UE 520 may be configured to measure and report in an aperiodic CSI report to assist with beam selection or beam management in an inter-cell beam management scenario.

As further shown in FIG. 5, in a second operation 550, the UE 520 may track a set of TCI states associated with the set of activated CSI trigger states based on a capability of the UE 520 to concurrently track TCI states. For example, as described herein, the TCI state associated with a CSI trigger state may provide QCL information associated with a corresponding beam (for example, large scale downlink QCL properties such as Doppler shift, Doppler spread, average delay, or delay spread that may be used for time and frequency tracking and inferred from one or more source reference signals having QCL type A, or an uplink spatial filter that may be derived from a downlink reference signal associated with QCL type D, among other examples). Accordingly, when the UE 520 tracks a TCI state associated with a particular CSI trigger state, the UE 520 may determine and maintain (for example, store) information related to the QCL properties associated with the corresponding source reference signal. In this way, when the UE 520 receives an indication to transmit or receive information using the TCI state, the UE 520 can apply the information related to the QCL properties associated with the corresponding TCI state to perform the transmission or reception.

In some aspects, for each CSI trigger state that is activated or down-selected (for example, by a MAC-CE), the UE 520 may track information associated with the corresponding TCI state. However, as described herein, the UE 520 may have a capability to concurrently track only up to a maximum quantity of TCI states that are associated with different PCIs (for example, TCI states in which an SSB from a non-serving cell 530 having a different PCI than the serving cell 510 provides the source reference signal from which the UE 520 derives QCL properties of the corresponding TCI states). Accordingly, when the set of activated CSI trigger states includes one or more CSI trigger states that are configured for inter-cell beam management, the UE may be configured to track or maintain time and frequency offset information or QCL properties associated with the non-serving cell SSBs that serve as source reference signals for the TCI states that correspond to such CSI trigger states. In such cases, the set of TCI states that the UE 520 is configured to track may include a total quantity of non-serving cell SSBs with different PCIs that does not exceed the capability of the UE 520 to concurrently track TCI states associated with different PCIs. Additionally or alternatively, the set of TCI states that the UE 520 is configured to track may include a total quantity of TCI states with a non-serving cell SSB as the source reference signal that does not exceed the capability of the UE 520 to concurrently track TCI states associated with different PCIs. Furthermore, in some aspects, the serving cell 510 may transmit, and the UE 520 may receive, information (for example, in a MAC-CE) that indicates a time duration (for example, a starting and ending time) in which the UE 520 is to track or maintain time and frequency offset information or QCL properties associated with SSBs from non-serving cells 530 that have different PCIs.

Accordingly, within the indicated time duration, the UE 520 may track a quantity of TCI states for which the source reference signal is a non-serving cell SSB or a quantity of non-serving cell SSBs that does not exceed the capability of the UE 520 to concurrently track, in a set of activated CSI trigger states, TCI states associated with different PCIs. For example, outside the indicated time duration, the UE 520 may refrain from tracking TCI states for which the source reference signal is a non-serving cell SSB or refrain from tracking non-serving cell SSBs, and within the indicated time duration, the UE 520 does not expect to track a quantity of non-serving cell SSBs or a quantity of TCI states having a non-serving cell SSB as a source reference signal that exceeds the corresponding capability of the UE 520. In cases where the UE 520 determines that the quantity of non-serving cell SSBs or the quantity of PCIs to be tracked exceeds the capability to concurrently track TCI states associated with different PCIs, the UE 520 may drop one or more TCI states that are associated with non-serving cell SSBs or non-serving cell PCIs from the set of tracked TCI states until the quantity of non-serving cell SSBs or the quantity of PCIs to be tracked does not exceed the capability of the UE 520. For example, in some aspects, the UE 520 may determine the TCI state(s) to be dropped from the set of tracked TCI states according to a timeline-based dropping rule or an identifier-based dropping rule.

For example, in an example of a timeline-based dropping rule, the UE 520 may track only a quantity of TCI states associated with CSI reports that were most recently triggered and within the capability of the UE 520 to concurrently track TCI states, and any other TCI states may be dropped (for example, if the UE 520 can concurrently track up to N TCI states, the UE 520 may track TCI states associated with the N most recent CSI trigger states for which a CSI report was triggered, and any other TCI states may be dropped from the set of TCI states tracked by the UE 520). Additionally or alternatively, in an example of an identifier-based dropping rule, the UE 520 may drop TCI states based on an order of PCIs or SSB identifiers. For example, the UE 520 may continue to track only a quantity of TCI states associated with the lowest or highest PCIs or SSB identifiers that are within the capability of the UE 520 to concurrently track TCI states, and any other TCI states may be dropped (for example, if the UE 520 can concurrently track up to N TCI states, the UE 520 may track TCI states associated with the N lowest or highest PCIs or SSB identifiers, and any other TCI states may be dropped from the set of tracked TCI states).

FIG. 6 is a flowchart illustrating an example process 600 performed, for example, by a UE in accordance with the present disclosure. Example process 600 is an example where the UE (for example, UE 120 or UE 520) performs operations associated with tracking TCI states in inter-cell beam management.

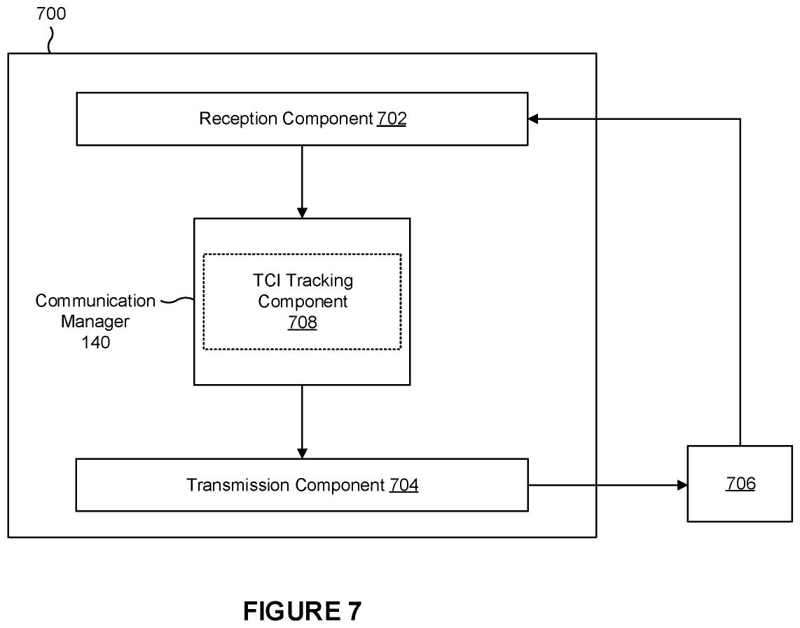

As shown in FIG. 6, in some aspects, process 600 may include receiving, from a serving cell, information indicating a set of activated CSI trigger states that are respectively associated with a set of TCI states each having a respective source reference signal (block 610). For example, the UE (such as by using communication manager 140 or reception component 702, depicted in FIG. 7) may receive, from a serving cell, information indicating a set of activated CSI trigger states that are respectively associated with a set of TCI states each having a respective source reference signal, as described above.

As further shown in FIG. 6, in some aspects, process 600 may include tracking, based at least in part on a capability to concurrently track multiple TCI states, a subset of TCI states, of the set of TCI states, including at least one TCI state for which the respective source reference signal is a non-serving cell SSB (block 620). For example, the UE (such as by using communication manager 140 or TCI tracking component 708, depicted in FIG. 7) may track, based at least in part on a capability to concurrently track multiple TCI states, a subset of TCI states, of the set of TCI states, including at least one TCI state for which the respective source reference signal is a non-serving cell SSB, as described above.

Process 600 may include additional aspects, such as any single aspect or any combination of aspects described below or in connection with one or more other processes described elsewhere herein.

In a first additional aspect, tracking the subset of TCI states for which the respective source reference signal is a non-serving cell SSB includes tracking one or more of a time and frequency offset or one or more QCL properties associated with the non-serving cell SSB.

In a second additional aspect, alone or in combination with the first aspect, the subset of TCI states includes a total quantity of non-serving cell SSBs with different PCIs that does not exceed the capability to concurrently track multiple TCI states.

In a third additional aspect, alone or in combination with one or more of the first and second aspects, the subset of TCI states includes a total quantity of TCI states for which the source reference signal is a non-serving cell SSB that does not exceed the capability to concurrently track multiple TCI states.

In a fourth additional aspect, alone or in combination with one or more of the first through third aspects, process 600 includes receiving information that indicates a time duration in which to track the subset of TCI states for which the respective source reference signal is a non-serving cell SSB.

In a fifth additional aspect, alone or in combination with one or more of the first through fourth aspects, a quantity of TCI states with a non-serving cell SSB as a source reference signal, or a quantity of non-serving cell SSBs that are tracked within the time duration, does not exceed the capability to concurrently track multiple TCI states.

In a sixth additional aspect, alone or in combination with one or more of the first through fifth aspects, process 600 includes determining that the subset of TCI states to be tracked is associated with a quantity of non-serving cell SSBs or a quantity of PCIs that exceeds the capability to concurrently track multiple TCI states, and dropping, from the subset of TCI states to be tracked, one or more TCI states associated with a non-serving cell SSB or a different PCI than the serving cell.

In a seventh additional aspect, alone or in combination with one or more of the first through sixth aspects, the one or more TCI states are dropped from the subset of TCI states to be tracked according to a timeline-based dropping rule until the quantity of non-serving cell SSBs or the quantity of PCIs included in the subset of TCI states to be tracked does not exceed the capability to concurrently track multiple TCI states.

In an eighth additional aspect, alone or in combination with one or more of the first through seventh aspects, the one or more TCI states are dropped from the subset of TCI states to be tracked according to an identifier-based dropping rule until the quantity of non-serving cell SSBs or the quantity of PCIs included in the subset of TCI states to be tracked does not exceed the capability to concurrently track multiple TCI states.

In a ninth additional aspect, alone or in combination with one or more of the first through eighth aspects, the set of activated CSI trigger states is indicated in a MAC-CE.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a base station, or another wireless communication device) using the reception component 702 and the transmission component 704.

In some aspects, the apparatus 700 may be configured to perform one or more operations described herein in connection with FIG. 5. Additionally or alternatively, the apparatus 700 may be configured to perform one or more processes described herein, such as process 600 of FIG. 6. In some aspects, the apparatus 700 may include one or more components of the UE described above in connection with FIG. 2.

The reception component 702 may receive communications, such as reference signals, control information, data communications, or a combination thereof, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a modem, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The communication manager 140 may receive or may cause the reception component 702 to receive, from a serving cell, information indicating a set of activated CSI trigger states that are respectively associated with a set of TCI states each having a respective source reference signal. The communication manager 140 may track, based at least in part on a capability to concurrently track multiple TCI states, a subset of TCI states, of the set of TCI states, including at least one TCI state for which the respective source reference signal is a non-serving cell SSB. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a TCI tracking component 708. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive, from a serving cell, information indicating a set of activated CSI trigger states that are respectively associated with a set of TCI states each having a respective source reference signal. The TCI tracking component 708 may track, based at least in part on a capability to concurrently track multiple TCI states, a subset of TCI states, of the set of TCI states, including at least one TCI state for which the respective source reference signal is a non-serving cell SSB.

The reception component 702 may receive information that indicates a time duration in which to track the subset of TCI states for which the respective source reference signal is a non-serving cell SSB.

The TCI tracking component 708 may determine that the subset of TCI states to be tracked is associated with a quantity of non-serving cell SSBs or a quantity of PCIs that exceeds the capability to concurrently track multiple TCI states. The TCI tracking component 708 may drop, from the subset of TCI states to be tracked, one or more TCI states associated with a non-serving cell SSB or a different PCI than the serving cell.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a UE, comprising: receiving, from a serving cell, information indicating a set of activated CSI trigger states that are respectively associated with a set of TCI states each having a respective source reference signal; and tracking, based at least in part on a capability to concurrently track multiple TCI states, a subset of TCI states, of the set of TCI states, including at least one TCI state for which the respective source reference signal is a non-serving cell SSB.

Aspect 2: The method of Aspect 1, wherein tracking the subset of TCI states for which the respective source reference signal is a non-serving cell SSB includes tracking one or more of a time and frequency offset or one or more QCL properties associated with the non-serving cell SSB.

Aspect 3: The method of any of Aspects 1-2, wherein the subset of TCI states includes a total quantity of non-serving cell SSBs with different PCIs that does not exceed the capability to concurrently track multiple TCI states.

Aspect 4: The method of any of Aspects 1-3, wherein the subset of TCI states includes a total quantity of TCI states for which the source reference signal is a non-serving cell SSB that does not exceed the capability to concurrently track multiple TCI states.

Aspect 5: The method of any of Aspects 1-4, further comprising receiving information that indicates a time duration in which to track the subset of TCI states for which the respective source reference signal is a non-serving cell SSB.

Aspect 6: The method of Aspect 5, wherein a quantity of TCI states with a non-serving cell SSB as a source reference signal, or a quantity of non-serving cell SSBs that are tracked within the time duration does not exceed the capability to concurrently track multiple TCI states.

Aspect 7: The method of any of Aspects 1-4, further comprising: determining that the subset of TCI states to be tracked is associated with a quantity of non-serving cell SSBs or a quantity of PCIs that exceeds the capability to concurrently track multiple TCI states; and dropping, from the subset of TCI states to be tracked, one or more TCI states associated with a non-serving cell SSB or a different PCI than the serving cell.

Aspect 8: The method of Aspect 7, wherein the one or more TCI states are dropped from the subset of TCI states to be tracked according to a timeline-based dropping rule until the quantity of non-serving cell SSBs or the quantity of PCIs included in the subset of TCI states to be tracked does not exceed the capability to concurrently track multiple TCI states.

Aspect 9: The method of Aspect 7, wherein the one or more TCI states are dropped from the subset of TCI states to be tracked according to an identifier-based dropping rule until the quantity of non-serving cell SSBs or the quantity of PCIs included in the subset of TCI states to be tracked does not exceed the capability to concurrently track multiple TCI states.

Aspect 10: The method of any of Aspects 1-9, wherein the set of activated CSI trigger states is indicated in a MAC-CE.

Aspect 11: An apparatus for wireless communication at a device, comprising a processor; memory coupled with the processor; and instructions stored in the memory and executable by the processor to cause the apparatus to perform the method of one or more of Aspects 1-10.

Aspect 12: A device for wireless communication, comprising a memory and one or more processors coupled to the memory, the one or more processors configured to perform the method of one or more of Aspects 1-10.

Aspect 13: An apparatus for wireless communication, comprising at least one means for performing the method of one or more of Aspects 1-10.

Aspect 14: A non-transitory computer-readable medium storing code for wireless communication, the code comprising instructions executable by a processor to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive, from a serving cell, information indicating a set of activated channel state information (CSI) trigger states that are respectively associated with a set of transmission configuration indication (TCI) states each having a respective source reference signal; and
track, based at least in part on a capability to concurrently track multiple TCI states, a subset of TCI states, of the set of TCI states, including at least one TCI state for which the respective source reference signal is a non-serving cell synchronization signal block (SSB).

2. The UE of claim 1, wherein, to cause the UE to track the subset of TCI states for which the respective source reference signal is a non-serving cell SSB, the processor-readable code, when executed by the at least one processor, is configured to cause the UE to track one or more of a time and frequency offset or one or more quasi co-location (QCL) properties associated with the non-serving cell SSB.

3. The UE of claim 1, wherein the subset of TCI states includes a total quantity of non-serving cell SSBs with different physical cell identities (PCIs) that does not exceed the capability to concurrently track multiple TCI states.

4. The UE of claim 1, wherein the subset of TCI states includes a total quantity of TCI states for which the source reference signal is a non-serving cell SSB that does not exceed the capability to concurrently track multiple TCI states.

5. The UE of claim 1, wherein the at least one memory further stores processor-readable code configured to cause the UE to receive information that indicates a time duration in which to track the subset of TCI states for which the respective source reference signal is a non-serving cell SSB.

6. The UE of claim 5, wherein a quantity of TCI states with a non-serving cell SSB as a source reference signal, or a quantity of non-serving cell SSBs that are tracked within the time duration does not exceed the capability to concurrently track multiple TCI states.

7. The UE of claim 1, wherein the at least one memory further stores processor-readable code configured to cause the UE to:
determine that the subset of TCI states to be tracked is associated with a quantity of non-serving cell SSBs or a quantity of physical cell identities (PCIs) that exceeds the capability to concurrently track multiple TCI states; and
drop, from the subset of TCI states to be tracked, one or more TCI states associated with a non-serving cell SSB or a different PCI than the serving cell.

8. The UE of claim 7, wherein the one or more TCI states are dropped from the subset of TCI states to be tracked according to a timeline-based dropping rule until the quantity of non-serving cell SSBs or the quantity of PCIs included in the subset of TCI states to be tracked does not exceed the capability to concurrently track multiple TCI states.

9. The UE of claim 7, wherein the one or more TCI states are dropped from the subset of TCI states to be tracked according to an identifier-based dropping rule until the quantity of non-serving cell SSBs or the quantity of PCIs included in the subset of TCI states to be tracked does not exceed the capability to concurrently track multiple TCI states.

10. The UE of claim 1, wherein the set of activated CSI trigger states is indicated in a medium access control (MAC) control element (MAC-CE).

11. A method of wireless communication performed by a user equipment (UE), comprising:
receiving, from a serving cell, information indicating a set of activated channel state information (CSI) trigger states that are respectively associated with a set of transmission configuration indication (TCI) states each having a respective source reference signal; and
tracking, based at least in part on a capability to concurrently track multiple TCI states, a subset of TCI states, of the set of TCI states, including at least one TCI state for which the respective source reference signal is a non-serving cell synchronization signal block (SSB).

12. The method of claim 11, wherein tracking the subset of TCI states for which the respective source reference signal is a non-serving cell SSB includes tracking one or more of a time and frequency offset or one or more quasi co-location (QCL) properties associated with the non-serving cell SSB.

13. The method of claim 11, wherein the subset of TCI states includes a total quantity of non-serving cell SSBs with different physical cell identities (PCIs) that does not exceed the capability to concurrently track multiple TCI states.

14. The method of claim 11, wherein the subset of TCI states includes a total quantity of TCI states for which the source reference signal is a non-serving cell SSB that does not exceed the capability to concurrently track multiple TCI states.

15. The method of claim 11, further comprising receiving information that indicates a time duration in which to track the subset of TCI states for which the respective source reference signal is a non-serving cell SSB.

16. The method of claim 15, wherein a quantity of TCI states with a non-serving cell SSB as a source reference signal, or a quantity of non-serving cell SSBs that are tracked within the time duration does not exceed the capability to concurrently track multiple TCI states.

17. The method of claim 11, further comprising:
determining that the subset of TCI states to be tracked is associated with a quantity of non-serving cell SSBs or a quantity of physical cell identities (PCIs) that exceeds the capability to concurrently track multiple TCI states; and
dropping, from the subset of TCI states to be tracked, one or more TCI states associated with a non-serving cell SSB or a different PCI than the serving cell.

18. The method of claim 17, wherein the one or more TCI states are dropped from the subset of TCI states to be tracked according to a timeline-based dropping rule until the quantity of non-serving cell SSBs or the quantity of PCIs included in the subset of TCI states to be tracked does not exceed the capability to concurrently track multiple TCI states.

19. The method of claim 17, wherein the one or more TCI states are dropped from the subset of TCI states to be tracked according to an identifier-based dropping rule until the quantity of non-serving cell SSBs or the quantity of PCIs included in the subset of TCI states to be tracked does not exceed the capability to concurrently track multiple TCI states.

20. The method of claim 11, wherein the set of activated CSI trigger states is indicated in a medium access control (MAC) control element (MAC-CE).

21. An apparatus for wireless communication, comprising:
means for receiving, from a serving cell, information indicating a set of activated channel state information (CSI) trigger states that are respectively associated with a set of transmission configuration indication (TCI) states each having a respective source reference signal; and
means for tracking, based at least in part on a capability to concurrently track multiple TCI states, a subset of TCI states, of the set of TCI states, including at least one TCI state for which the respective source reference signal is a non-serving cell synchronization signal block (SSB).

22. The apparatus of claim 21, wherein the means for tracking the subset of TCI states for which the respective source reference signal is a non-serving cell SSB includes means for tracking one or more of a time and frequency offset or one or more quasi co-location (QCL) properties associated with the non-serving cell SSB.

23. The apparatus of claim 21, wherein the subset of TCI states includes a total quantity of non-serving cell SSBs with different physical cell identities (PCIs) or a total quantity of TCI states for which the source reference signal is a non-serving cell SSB that does not exceed the capability to concurrently track multiple TCI states.

24. The apparatus of claim 21, further comprising means for receiving information that indicates a time duration in which to track the subset of TCI states for which the respective source reference signal is a non-serving cell SSB.

25. The apparatus of claim 21, further comprising:
means for determining that the subset of TCI states to be tracked is associated with a quantity of non-serving cell SSBs or a quantity of physical cell identities (PCIs) that exceeds the capability to concurrently track multiple TCI states; and
means for dropping, from the subset of TCI states to be tracked, one or more TCI states associated with a non-serving cell SSB or a different PCI than the serving cell.
